(19) United States
(12) Patent Application Publication
(10) Pub. No.: US 2004/0069171 A1
(43) Pub. Date: Apr. 15, 2004

(54) Water pattern transfer for printing pattern on computer casing

(76) Inventor: Hsiangpin Michael Chang, Sugar Land, TX (US)

Correspondence Address: Hsiangpin Michael Chang, 235 Chung-Ho, Box 8-24, Taipei, TW

(21) Appl. No.: 10/361,178

(22) Filed: Feb. 10, 2003

(30) Foreign Application Priority Data
Oct. 9, 2002 (TW) 091123361

(51) Int. Cl. B41C 1/00

(52) U.S. Cl. 101/483

(57) ABSTRACT

A water pattern transfer method serves for printing a pattern on a computer casing. The method comprises the steps of forming a computer casing by punching, forming a pattern; forming a pattern transfer film; performing a floating process: wherein the water transferred film to be printed is placed in a water transfer groove; and then an activator is solved in the water so that the ink pattern on the water transfer film is activated and reduced; performing pattern transfer printing process; wherein the ink pattern is adhered to the panel of the casing or on the casing so that a pattern is transferred to the substrate; cleaning and drying; wherein the casing and panel with patterns are cleaned by water and then they are dried; and performing surface process, wherein an assistant agent is adhered on a surface of the computer casing; and assembling the substrate to other components of a computer.

### FIELD OF THE INVENTION

The present invention relates to a method for coloring a computer casing, and particularly to a method of water pattern transfer for printing pattern on a computer casing.

### BACKGROUND OF THE INVENTION

Computers have been a popular product in homes, offices, plants, etc. Thereby, the outlook of computer has become an important feature in the appearance of a space. However, in the prior art, the casing of a computer is dull and in general no pattern or texture is formed on computer casings.

In the prior art, the computer casing made of metals or plastics are made by punching and then panels of the casing are formed by mold-injection. Then paints are coated on the casing manually. Then the paint-coated casing is dried and then is placed in a dustless chamber to be processed further. Then other components of the computer is assembled with the casing.

In general the color of the computer is gray or black and thus the casings are dull. Moreover, the dustless chamber is expensive. The assistant agent for coating paints on the casing will pollute the environment and has a bad effect to the human body. Moreover, paints are harmful to human bodies and will fade with the using time of the computer.

### SUMMARY OF THE INVENTION

Accordingly, the primary object of the present invention is to provide a water pattern transfer method for printing pattern on a computer casing, wherein textures are formed on the casing so as to present a beautiful outlook.

Another object of the present invention is to provide a water pattern transfer method for printing pattern on a computer casing, wherein no paint is used and thus it is harmless to the human body.

A further object of the present invention is to provide a water pattern transfer method for printing pattern on a computer casing, wherein the textures will not fade with the using time.

A yet object of the present invention is to provide a water pattern transfer method for printing pattern on a computer casing, wherein no dustless chamber is used, and thus the cost is low and the process is simple.

To achieve the object, the present invention provides a water pattern transfer method for printing pattern on a computer casing comprising the steps of: forming a substrate, wherein the computer casing made of metals or plastics are made by punching and then panels of the casing is formed by injection; forming a pattern, wherein an initial film is formed with colored pattern; forming a pattern transfer film, wherein the patter on the initial firm is transferred to a water-solvable water transferred film and an ink pattern is formed on the water transfer film; performing a floating process: wherein the printed water transferred film is placed in a water transfer groove; in that the water transferred film is suffered from the tension force of water, and then the activator is solved in the water so that the ink pattern on the water transfer film is activated and reduced, (referring to FIG. 3); performing pattern transfer printing process; wherein the substrate is sunk in the water transfer groove (referring to FIG. 4); by the tension force of water, the ink pattern is adhered to the panel of the casing or on the casing so that a pattern is transferred to the substrate; cleaning and drying; wherein the casing and panel with patterns are cleaned by water and then they are dried; performing surface process: an assistant is adhered on the surface of the substrate; and assembling the substrate to other components of a computer.

The various objects and advantages of the present invention will be more readily understood from the following detailed description when read in conjunction with the appended drawing.

### BRIEF DESCRIPTION OF THE DRAWINGS

FIG. 1 is a block diagram showing the process of the present invention.

FIG. 2 shows a process of the present invention where a pattern is printed to a water transfer film.

FIG. 3 shows the floating process of the present invention.

FIG. 4 is a schematic view showing that the film is sunk in a water transfer groove for pattern transfer.

FIG. 5 shows that in the present invention, wood texture is transferred to a computer casing, wherein FIG. 5A shows a prior art and FIG. 5B is a schematic view showing that the door of a casing is opened.

FIG. 6 shows that another wood texture is transferred to a computer casing.

FIG. 7 shows that the jade texture is transferred to a computer casing.

### DETAILED DESCRIPTION OF THE PREFERRED EMBODIMENTS

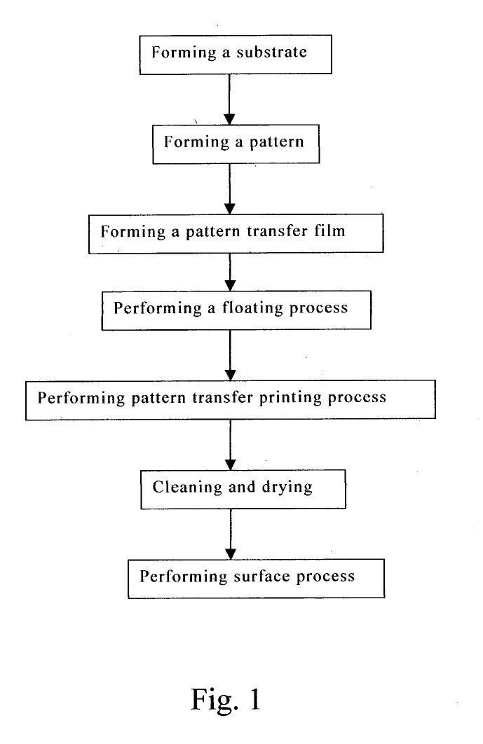

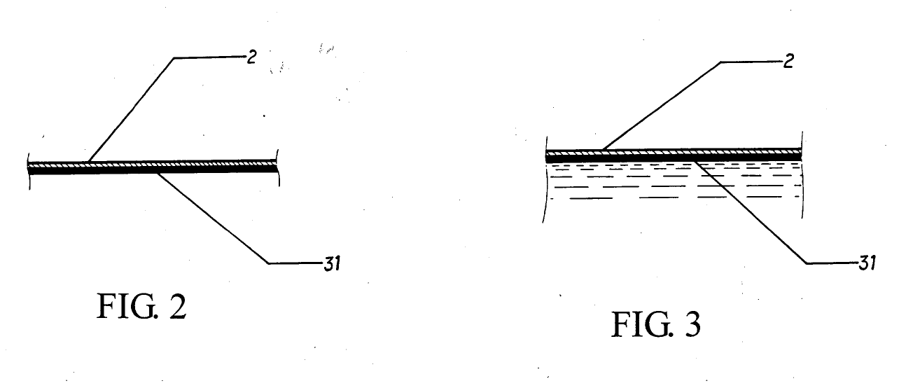

Referring to FIGS. 1 to 3, the manufacturing method of the present invention comprises the following steps.

Forming a substrate, wherein the computer casing forming by metals or plastics are made by punching and then panels of the casing is formed by mold injection.

Forming a pattern, wherein an initial film is formed with a colored pattern by computer added design technique.

Forming a pattern transfer film, wherein the patter on the initial firm is read and then write to a water-solvable water transferred film 31 and an ink pattern is formed on the water transfer film 31.

Performing a floating process: wherein the printed water transferred film is placed in a water transfer groove (not shown); in that the water transferred film is suffered from the tension force of water, and then the activator is solved in the water so that the ink pattern on the water transfer film 31 is activated and reduced, (referring to FIG. 3).

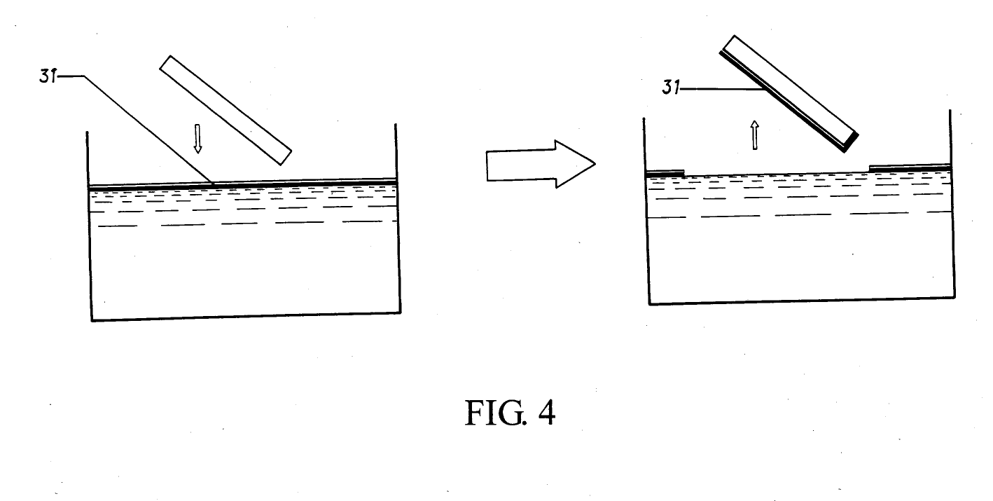

Performing pattern transfer printing process; wherein the substrate is sunk in the water transfer groove (referring to FIG. 4); by the tension force of water, the ink pattern is adhered to the panel of the casing or on the casing so that a pattern is transferred to the substrate.

Cleaning and drying; wherein the casing and panel with patterns are cleaned by water and then they are dried; and

performing surface process: an assistant is adhered on the surface of the substrate.

Thereby, the substrate and panels thereon can be processed by floating process and printing transfer so that the ink pattern is adhered on the substrate and then the substrate is assembled (8) so as to complete the process.

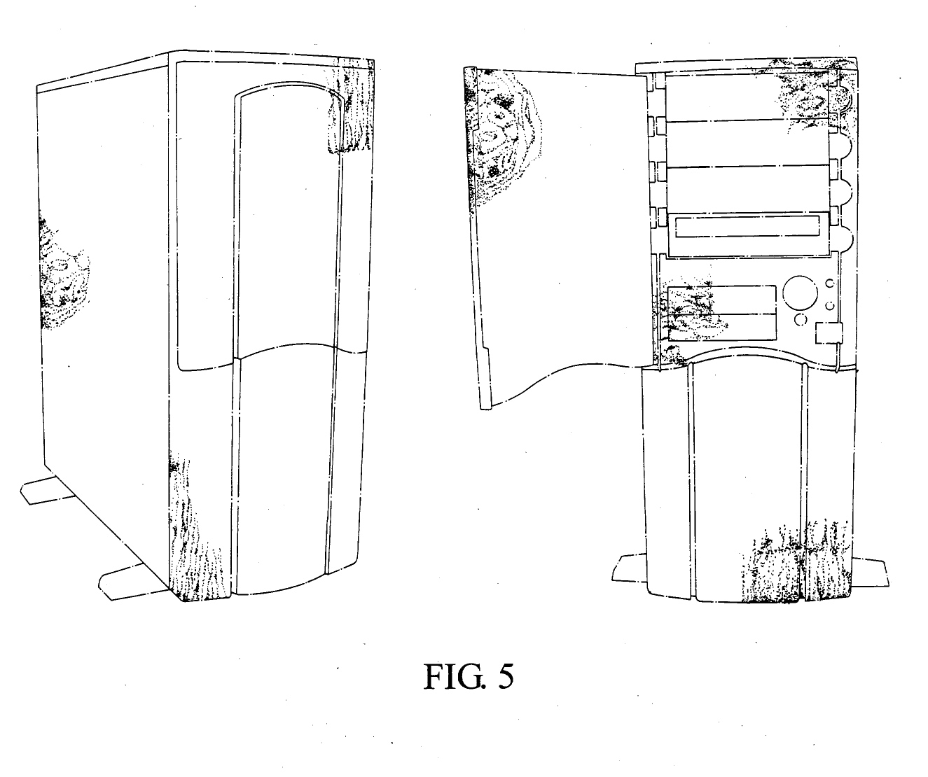

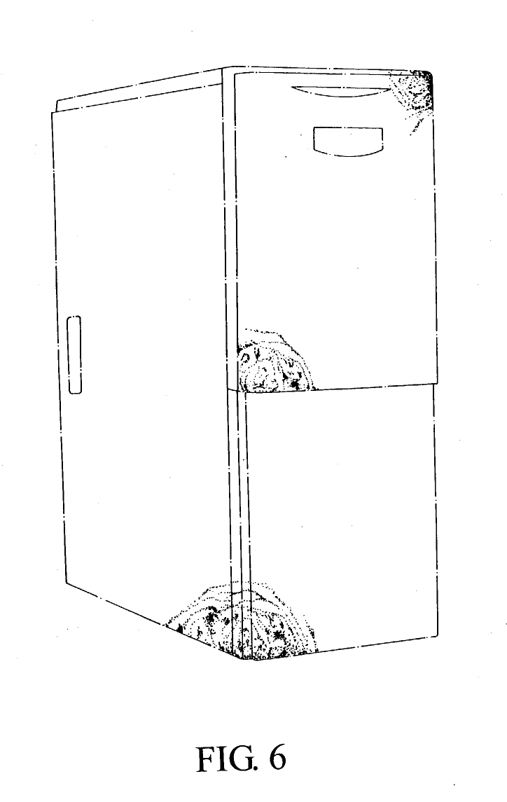

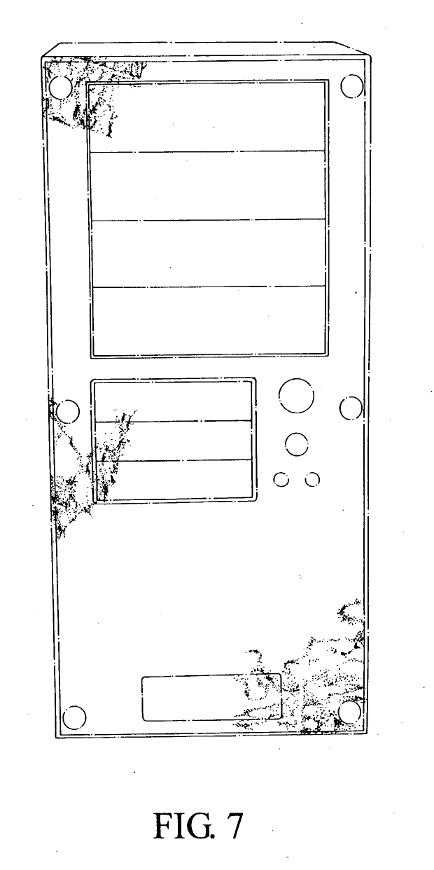

Referring to FIGS. 5 and 6, it is illustrated that wood texture is transferred to outer surfaces of a computer casing. In that, a pattern can be easily transferred to a casing of the water transfer film (31). In FIG. 5, the pattern is like the texture of a redwood and in FIG. 6, the pattern is like the texture of walnut wood. Other texture, like texture of jade can be used, as shown in the FIG. 7. However, other textures can be used in the present invention.

In the present invention, the assistant used in the surface process is a transparent glue.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A water pattern transfer method for printing a pattern on a computer casing comprising the steps of:
forming a computer casing by punching, wherein the computer casing is made of metals or plastics and then panels of the casing is formed by injection;
forming a pattern, wherein an initial film is formed with a colored pattern;
forming a pattern transfer film, wherein the colored patter on the initial firm is transferred to a water-solvable water transferred film and an ink pattern is formed on the water transferred film;
performing a floating process: wherein the water transferred film to be printed is placed in a water transfer groove; in that the water transferred film is suffered from the tension force of water, and then an activator is solved in the water so that the ink pattern on the water transfer film is activated and reduced;
performing pattern transfer printing process; wherein the substrate is sunk in the water transfer groove; by the tension force of water, the ink pattern is adhered to the panel of the casing or on the casing so that a pattern is transferred to the substrate.
cleaning and drying; wherein the casing and panel with patterns are cleaned by water and then they are dried;
performing surface process, wherein an assistant agent is adhered on a surface of the computer casing; and
assembling the substrate to other components of a computer.

2. The water pattern transfer method for printing a pattern on a computer casing as claim in claim 1, wherein the pattern is selected from one of wood textures, stone textures, cloth textures and geometric patterns.

3. The water pattern transfer method for printing a pattern on a computer casing as claim in claim 1, wherein the assistant used in the surface process is a transparent glue.

4. The water pattern transfer method for printing a pattern on a computer casing as claim in claim 1, wherein the initial film is formed with colored pattern by computer added design technique and a printer is connected to a computer for performing computer added design, the printer reads the pattern on the initial film and write the pattern to the water transfer film.
